(19) United States
(12) Patent Application Publication
(10) Pub. No.: US 2017/0111593 A1
(43) Pub. Date: Apr. 20, 2017

(54) SYSTEM, METHOD AND APPARATUS FOR CAPTURE, CONVEYING AND SECURING INFORMATION INCLUDING MEDIA INFORMATION SUCH AS VIDEO

(71) Applicant: CEDAR CREST PARTNERS INC., Southampton, NY (US)

(72) Inventor: Craig P. Mowry, Southampton, NY (US)

(21) Appl. No.: 14/989,596

(22) Filed: Jan. 6, 2016

Related U.S. Application Data
(63) Continuation-in-part of application No. 14/861,646, filed on Sep. 22, 2015, now abandoned.
(60) Provisional application No. 62/053,438, filed on Sep. 22, 2014.
(60) Provisional application No. 62/129,550, filed on Mar. 6, 2015.
(60) Provisional application No. 62/143,663, filed on Apr. 6, 2015.
(60) Provisional application No. 62/175,830, filed on Jun. 15, 2015.

(51) Int. Cl. H04N 5/262; H04N 1/32; H04N 1/00

(52) U.S. Cl. CPC H04N 5/2624; H04N 1/00214; H04N 1/32149; H04N 2201/3281; H04N 2201/0084

(57) ABSTRACT

A system and method include a first subsystem that includes at least one image capture device configured to capture a plurality of image captures of a visual scene and to generate first image information associated with at least one of the plurality of image captures. A second subsystem includes at least one image-related device positioned offset of at least one image capture device and is configured to capture information associated with the visual scene. At least one processor is configured to communicate with at least one image-related device of the second subsystem, correlate information received from at least one image-related device of the second subsystem with at least some of the first image information; and generate image presentation information as a function of the correlated information; wherein the generated image presentation information is usable to present an altered version of at least one of the plurality of image captures.

### CROSS-REFERENCE TO RELATED APPLICATIONS

This application is a continuation-in-part of U.S. Non-Provisional application Ser. No. 14/861,646, filed Sep. 22, 2015, entitled “SYSTEM, METHOD AND APPARATUS FOR CAPTURE, CONVEYING AND SECURING INFORMATION INCLUDING MEDIA INFORMATION SUCH AS VIDEO,” which is based on and claims priority to U.S. Provisional application Ser. No. 62/053,438, entitled “SYSTEM, METHOD AND APPARATUS FOR CAPTURE, CONVEYING AND SECURING INFORMATION INCLUDING MEDIA INFORMATION SUCH AS VIDEO,” filed Sep. 22, 2014, and this application is further based on and claims priority to U.S. Provisional application Ser. No. 62/129,550 and entitled “MULTI DIMENSIONAL IMAGING COMPONENT SYSTEM AND METHOD” and filed Mar. 6, 2015, and to U.S. Provisional application Ser. No. 62/143,663 and entitled “KEY FRAME AND MULTIDIMENSIONAL BASED IMAGE AND DIMENSIONAL INFERENCE VIA WIRELESS DEVICE” and filed Apr. 6, 2015, and to U.S. Provisional application Ser. No. 62/175,830 and entitled “KEY FRAME AND MULTIDIMENSIONAL BASED IMAGE AND DIMENSIONAL INFERENCE VIA WIRELESS DEVICE” and filed Jun. 15, 2015, the entire contents of all of which are incorporated by reference herein.

This application further incorporates by reference U.S. patent application Ser. No. 13/646,417, entitled “SYSTEM AND APPARATUS FOR INCREASING QUALITY AND EFFICIENCY OF FILM CAPTURE AND METHODS OF USE THEREOF,” filed Oct. 5, 2012, which is a continuation of U.S. patent application Ser. No. 11/611,793, entitled “SYSTEM AND APPARATUS FOR INCREASING QUALITY AND EFFICIENCY OF FILM CAPTURE AND METHODS OF USE THEREOF,” filed Dec. 15, 2006, which is a continuation-in-part application of U.S. patent application Ser. No. 11/510,091, entitled “SYSTEM AND APPARATUS FOR INCREASING QUALITY AND EFFICIENCY OF FILM CAPTURE AND METHODS OF USE THEREOF,” filed on Aug. 25, 2006. The present application is also based on and claims priority to U.S. Provisional Application Ser. No. 60/750,912, entitled “A METHOD, SYSTEM AND APPARATUS FOR INCREASING QUALITY AND EFFICIENCY OF (DIGITAL) FILM CAPTURE,” filed on Dec. 15, 2005. The entireties of each of the foregoing patent applications is hereby incorporated by reference.

This application further incorporates by reference in their entireties, U.S. patent application Ser. No. 11/562,840, entitled, “COMPOSITE MEDIA RECORDING ELEMENT AND IMAGING SYSTEM AND METHOD OF USE THEREOF” filed on Nov. 22, 2006; U.S. patent application Ser. No. 11/549,937, entitled “APPARATUS, SYSTEM AND METHOD FOR INCREASING QUALITY OF DIGITAL IMAGE CAPTURE,” filed on Oct. 16, 2006; U.S. patent application Ser. No. 11/495,933, filed Jul. 27, 2006, entitled: SYSTEM, APPARATUS, AND METHOD FOR CAPTURING AND SCREENING VISUAL IMAGES FOR MULTI-DIMENSIONAL DISPLAY, a U.S. non-provisional application that claims the benefit of U.S. Provisional Application Ser. No. 60/702,910, filed on Jul. 27, 2005; U.S. patent application Ser. No. 11/492,397, filed Jul. 24, 2006, entitled: SYSTEM, APPARATUS, AND METHOD FOR INCREASING MEDIA STORAGE CAPACITY, a U.S. non-provisional application which claims the benefit of U.S. Provisional Application Ser. No. 60/701,424, filed on Jul. 22, 2005; and U.S. patent application Ser. No. 11/472,728, filed Jun. 21, 2006, entitled: SYSTEM AND METHOD FOR INCREASING EFFICIENCY AND QUALITY FOR EXPOSING IMAGES ON CELLULOID OR OTHER PHOTO SENSITIVE MATERIAL, a U.S. non-provisional application which claims the benefit of U.S. Provisional Application No. 60/692,502, filed Jun. 21, 2005; the entire contents of which are as if set forth herein in their entirety. This application further incorporates by reference in their entirety, U.S. patent application Ser. No. 11/481,526, filed Jul. 6, 2006, entitled “SYSTEM AND METHOD FOR CAPTURING VISUAL DATA AND NON-VISUAL DATA FOR MULTIDIMENSIONAL IMAGE DISPLAY,” U.S. patent application Ser. No. 11/473,570, filed Jun. 22, 2006, entitled “SYSTEM AND METHOD FOR DIGITAL FILM SIMULATION,” U.S. patent application Ser. No. 11/472,728, filed Jun. 21, 2006, entitled “SYSTEM AND METHOD FOR INCREASING EFFICIENCY AND QUALITY FOR EXPOSING IMAGES ON CELLULOID OR OTHER PHOTO SENSITIVE MATERIAL,” U.S. patent application Ser. No. 11/447,406, entitled “MULTI-DIMENSIONAL IMAGING SYSTEM AND METHOD,” filed on Jun. 5, 2006, and U.S. patent application Ser. No. 11/408,389, entitled “SYSTEM AND METHOD TO SIMULATE FILM OR OTHER IMAGING MEDIA” and filed on Apr. 20, 2006. The entireties of each of the foregoing patent applications is hereby incorporated by reference.

### FIELD

In one aspect the present application provides a hybrid and/or tandem application of image capture settings, including a selectable number of images used to create a selective final resolution image(s), and selectively the number of information groups created from other information captured to inform positional aspects of those image portion captures/images.

### BACKGROUND

As cinema and television technology converge, allowing the home viewer to enjoy many of the technological benefits once reserved for movie theaters, the need initially for additional experiential impact in theaters increases. Resolution, choice, sound and other aspects of home viewing have improved and expanded, as have the viewing options and quality of media presented by computer and Internet options. In time, any benefit of the cinema experience will be minimized to the point of potentially threatening that viewing venue, and industry, entirely.

Currently, no system or method exists in the prior art to provide superior visuals, for example, in terms of resolution and multi-dimensionally, securely and without a need for added hardware configurations. It is with respect to these and other considerations that the disclosure made herein is presented.

### SUMMARY OF THE INVENTION

A system and method include a first subsystem that includes at least one image capture device configured to capture a plurality of image captures of a visual scene and to generate first image information associated with at least one of the plurality of image captures. A second subsystem includes at least one image-related device positioned offset of at least one image capture device and is configured to capture information associated with the visual scene. At least one processor is configured to communicate with at least one image-related device of the second subsystem, correlate information received from at least one image-related device of the second subsystem with at least some of the first image information; and generate image presentation information as a function of the correlated information; wherein the generated image presentation information is usable to present an altered version of at least one of the plurality of image captures.

Other features and advantages of the present application will become apparent from the following description of the invention that refers to the accompanying drawings.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a diagram illustrating an example hardware arrangement that operates for providing the systems and methods disclosed herein;

FIG. 2 is a block diagram that illustrates functional elements of a computing device in accordance with an embodiment;

FIGS. 3A-3C are simple block diagrams representing image capture sequence and framing;

FIG. 3D is a flow diagram illustrating steps associated with an example implementation; and

FIG. 4 illustrates an example representation, which includes a viewing area that includes a plurality of devices capturing a visual scene.

### DETAILED DESCRIPTION

The present application regards imaging. By way of overview and introduction, the present application uniquely balances the technological interests of capturing a maximal amount of information, such as to provide for a high image resolution and other desired attributes, with conveying as little information and/or data in as secure manner as possible in order to provide image information that is suitable for screening and/or subsequent postproduction activity. The present application addresses these conflicting interests and objectives in ways that were, until now, unavailable.

Various embodiments and aspects of the invention(s) will be described with reference to details discussed below, and the accompanying drawings illustrate the various embodiments. The following description and drawings are illustrative of the invention and are not to be construed as limiting. Numerous specific details are described to provide a thorough understanding of various embodiments of the present invention. However, in certain instances, well-known or conventional details are not described in order to provide a concise discussion of embodiments of the present application.

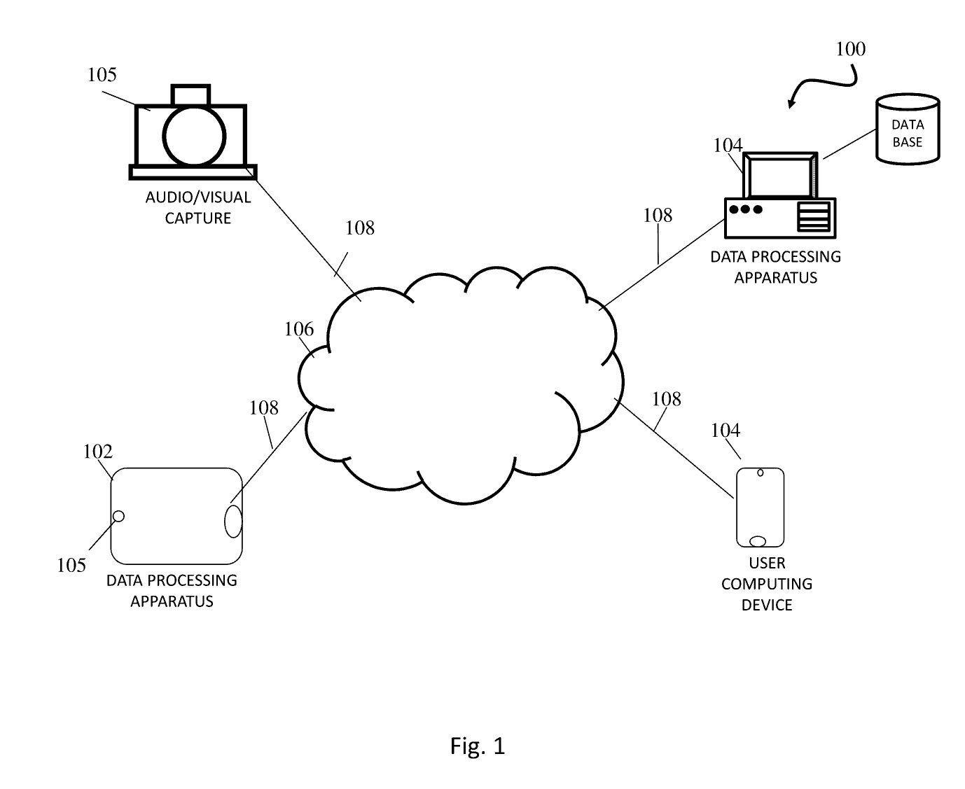

Referring to FIG. 1 a diagram is provided of an example hardware arrangement that operates for providing the systems and methods disclosed herein, and designated generally as system 100. System 100 can include one or more data processing apparatuses 102 that are at least communicatively coupled to one or more user computing devices 104 across communication network 106. Data processing apparatuses 102 and user computing devices 104 can include, for example, mobile computing devices such as tablet computing devices, smartphones, personal digital assistants or the like, as well as laptop computers and/or desktop computers. Further, one computing device may be configured as a data processing apparatus 102 and a user computing device 104, depending upon operations be executed at a particular time. In addition, an audio/visual capture device 105 is depicted in FIG. 1, which can be configured with one or more cameras (e.g., front-facing and rear-facing cameras), a microphone, a microprocessor, and a communications module(s). The audio/visual capture device 105 can be configured to interface with one or more data processing apparatuses 102 for producing high-quality image, audio and/or video content.

With continued reference to FIG. 1, data processing apparatus 102 can be configured to access one or more databases for the present application, including image files, video content, documents, audio/video recordings, metadata and other information. However, it is contemplated that data processing apparatus 102 can access any required databases via communication network 106 or any other communication network to which data processing apparatus 102 has access. Data processing apparatus 102 can communicate with devices comprising databases using any known communication method, including a direct serial, parallel, universal serial bus (“USB”) interface, or via a local or wide area network.

User computing devices 104 communicate with data processing apparatuses 102 using data connections 108, which are respectively coupled to communication network 106. Communication network 106 can be any communication network, but is typically the Internet or some other global computer network. Data connections 108 can be any known arrangement for accessing communication network 106, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 104 preferably have the ability to send and receive data across communication network 106, and can be equipped with cameras, microphones and software applications, including web browsers or other applications, to provide data to and from devices 102 and 105. By way of example, user computing device 104 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 106, and that wireless communication can be provided between wireless devices and data processing apparatuses 102. In one or more implementations, the present application provides improved processing techniques to prevent packet loss, to improve handling interruptions in communications, and other issues associated with wireless technology.

According to an embodiment of the present application, user computing device 104 provides user access to data processing apparatus 102 for the purpose of receiving and providing information. The specific functionality provided by system 100, and in particular data processing apparatuses 102, is described in detail below.

System 100 preferably includes software that provides functionality described in greater detail herein, and preferably resides on one or more data processing apparatuses 102 and/or user computing devices 104. One of the functions performed by data processing apparatus 102 is that of operating as a web server and/or a web site host. Data processing apparatuses 102 typically communicate with communication network 106 across a permanent i.e., un-switched data connection 108. Permanent connectivity ensures that access to data processing apparatuses 102 is always available.

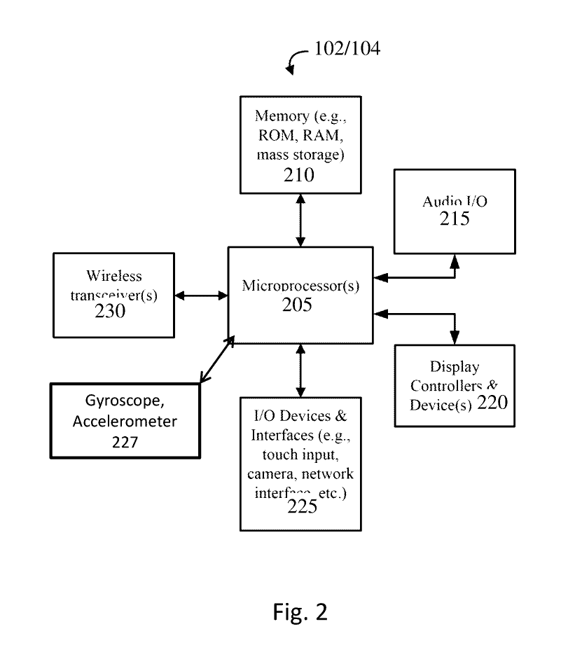

FIG. 2 illustrates, in block diagram form, an exemplary data processing apparatus 102 and/or user computing device 104 that can provide functionality in accordance with the teachings herein. Although not expressly indicated, one or more features shown and described with reference with FIG. 2 can be included with or in the audio/visual capture device 105, as well. Data processing apparatus 102 and/or user computing device 104 may include one or more microprocessors 205 and connected system components (e.g., multiple connected chips) or the data processing apparatus 102 and/or user computing device 104 may be a system on a chip.

The data processing apparatus 102 and/or user computing device 104 includes memory 210 which is coupled to the microprocessor(s) 205. The memory 210 may be used for storing data, metadata, and programs for execution by the microprocessor(s) 205. The memory 210 may include one or more of volatile and non-volatile memories, such as Random Access Memory (“RAM”), Read Only Memory (“ROM”), Flash, Phase Change Memory (“PCM”), or other type

The data processing apparatus 102 and/or user computing device 104 also includes an audio input/output subsystem 215 which may include a microphone and/or a speaker for, for example, playing back music, providing voice/video functionality through the speaker and microphone, etc.

A display controller and display device 220 provides a visual user interface for the user; this user interface may include a graphical user interface which, for example, is similar to that shown on a Macintosh computer when running Mac OS operating system software or an iPad, iPhone, or similar device when running iOS operating system software.

The data processing apparatus 102 and/or user computing device 104 also includes one or more wireless transceivers 230, such as an IEEE 802.11 transceiver, an infrared transceiver, a Bluetooth transceiver, a wireless cellular telephony transceiver (e.g., 1G, 2G, 3G, 4G), or another wireless protocol to connect the data processing system 100 with another device, external component, or a network. In addition, Gyroscope/Accelerometer 235 can be provided

It will be appreciated that one or more buses, may be used to interconnect the various modules in the block diagram shown in FIG. 2.

The data processing apparatus 102 and/or user computing device 104 may be a personal computer, tablet-style device, such as an iPad, a personal digital assistant (PDA), a cellular telephone with PDA-like functionality, such as an iPhone, a Wi-Fi based telephone, a handheld computer which includes a cellular telephone, a media player, such as an iPod, an entertainment system, such as a iPod touch, or devices which combine aspects or functions of these devices, such as a media player combined with a PDA and a cellular telephone in one device. In other embodiments, the data processing apparatus 102 and/or user computing device 104 may be a network computer or an embedded processing apparatus within another device or consumer electronic product.

The data processing apparatus 102 and/or user computing device 104 also includes one or more input or output (“I/O”) devices and interfaces 225 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the data processing apparatus 102 and/or user computing device 104. The I/O devices and interfaces 225 may include a connector for a dock or a connector for a USB interface, FireWire, etc. to connect the system 100 with another device, external component, or a network. Moreover, the I/O devices and interfaces can include gyroscope and/or accelerometer 227, which can be configured to detect 3-axis angular acceleration around the X, Y and Z axes, enabling precise calculation, for example, of yaw, pitch, and roll. The gyroscope and/or accelerometer 227 can be configured as a sensor that detects acceleration, shake, vibration shock, or fall of a device 102/104, for example, by detecting linear acceleration along one of three axes (X, Y and Z). The gyroscope can work in conjunction with the accelerometer, to provide detailed and precise information about the device's axial movement in space. More particularly, the 3-axes of the gyroscope combined with the 3-axes of the accelerometer enable the device to recognize approximately how far, fast, and in which direction it has moved to generate telemetry information associated therewith.

It will be appreciated that additional components, not shown, may also be part of the data processing apparatus 102 and/or user computing device 104, and, in certain embodiments, fewer components than that shown in FIG. 2 may also be used in data processing apparatus 102 and/or user computing device 104. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 210 or other machine-readable storage medium. The software may further be transmitted or received over a network (not shown) via a network interface device 225. In various embodiments, hardwired circuitry may be used in combination with the software instructions to implement the present embodiments. Thus, the techniques are not limited to any specific combination of hardware circuitry and software, or to any particular source for the instructions executed by the data processing apparatus 102 and/or user computing device 104.

In one or more implementations, a system and method are provided that attributes a vast amount of data to images. For example, image information may pertain to one second of screen-time, based on 24 frames per second. One skilled in the art will recognize that higher frame rates, such as 48 frames per second, may be a basis for providing a time unit of one second of motion images (e.g., digital video). As shown and described herein, the present application improves processes associated with image capture, image processing and/or image conveyance, and improves computer technology by creating new pathways for new imaging results, thereby fulfilling multiple areas of tandem value.

In one or more implementations of the present patent application, a camera 105 is configured as a component in an overall system 100. The camera 105 may be configured to reposition an electronic capture device, such as a light-sensitive digitizing capture component (e.g., a digital camera image sensor). Alternatively, or in addition, all or a portion of a light pathway may be repositioned with respect to a visual scene vis-à-vis a light-transmitting lens. The light transmitting lens can involve optics and/or other options, such as magnetic or other light pathway affecting imposition, which can impact an aspect of light that is reflected and/or generated with regard to one or more objects within a visual scene and that represent a desired capture area. The desired capture area can be referred to herein, generally, as the “live area,” which represents the portion of a monitor image that is masked off' and represents an image portion that is intended for at least one eventual screening system(s) dimensional requirements.

Thus, the present application includes a system that can be configured such that a capture device and/or a light pathway is repositioned, thereby supporting multiple captures of portions of a particular and potentially larger overall visual area. As used herein, a light pathway refers, generally, to light that comes from (e.g., reflects from) objects within a visual scene. In accordance with the present application, a simple three-position shift may allow for a “triptych” capture representing the “top” “middle” and “bottom” portions of the scene. Alternatively, the triptych capture may represent the “left” “middle” and “right” portions of the scene. Other partitions are supported, as well. This plurality of captures, i.e. a simple three position shift, can allow a single 20-megapixel capture device (e.g., an image sensor or chip) to provide for a 60-megapixel triptych, which can be digitally composited by the present application to form a seamless “key frame” image for subsequent use, such as in generating inferred image information.

The present application is further suitable for cinema, and a 4K capture can be used to allow for maximum image information result of up to 12K, without requiring an alteration of the size or power of the capture device 105. Instead, by repositioning the capture device and/or the light pathway, coverage of a greater image target zone relative to a desired visual scene than would be possible using a typical single capture 4K camera.

In one or more implementations of the present application, “composited” key frames can occur at any time(s) during, for example, a single one-second period of time. The composited key frames can represent two or more “moments” in time during a one-second period of time. In one or more implementations, a second system of image-related devices can be provided that is compatible and associated with the first composite key frame system, which collects information associated with one or more objects within a desired visual scene. The second system can include, for example, one or more user computing devices 104. The information collected by the second system may be visual, such as distinct image captures that are of the same or lower resolution than any one single capture related to the “mosaic” composite image portions of the composite key frame device, such as capture device 105. This allows for increased data conveyance efficiency, by precluding the need to convey image information at a high resolution.

In one or more implementations, associated image portions that are discernible, for example, to one or more computing devices provides a basis for applying a lower resolution image, or even simply spatial data such as a reflected signal-based readings to provide a “wireframe” relief map of a visual scene from a camera's point of view and/or one or more other points of view. The associated image portions may pertain to a single object within a desired visual scene. Using the low resolution, spatial data or other information from the “second” system, composited mosaic key frame information can be revised as image data is correspondingly altered.

The present application provides a computer-managed inference that can be made as a function of a mosaic composited image that is tantamount to an image taken by an extremely high resolution capture device at a particular moment during a one-second period of time. The inference can occur as the second system provides information representing one or more objects in the frame that may shift from one position to another at the particular instance of capture. Color and other image-related shifts can be detected by the second system and represented in information associated therewith, which can also be affected. Accordingly, selective updates may be indicated to account for variations that occur more frequently than once per second, in order to maintain image continuity and to provide an authentic representation of action that occurred during the time within the live area.

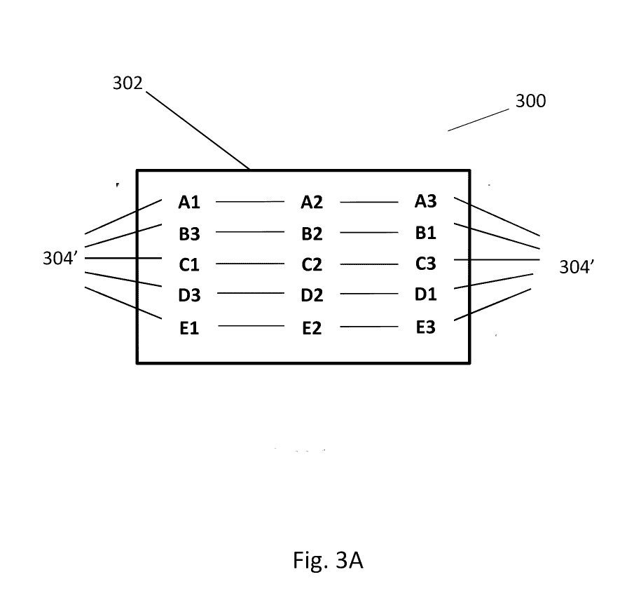

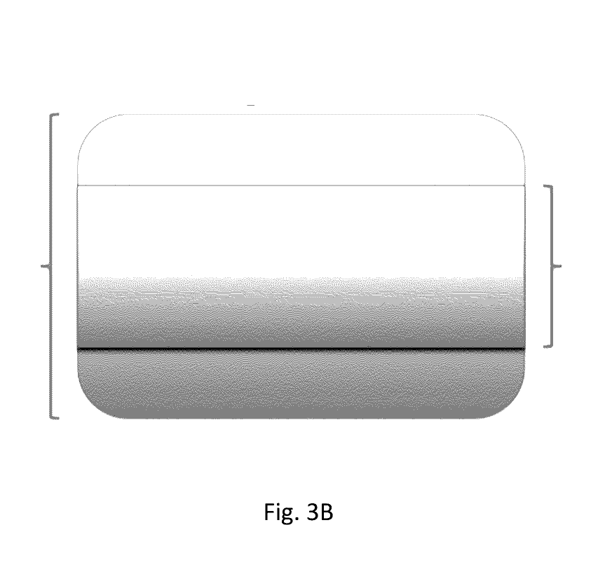

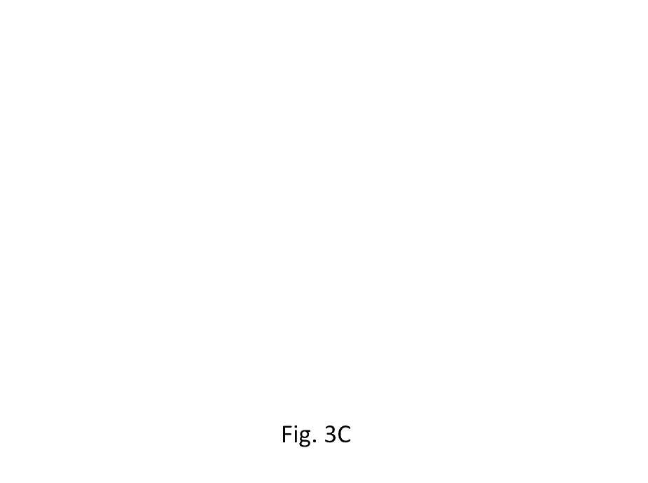

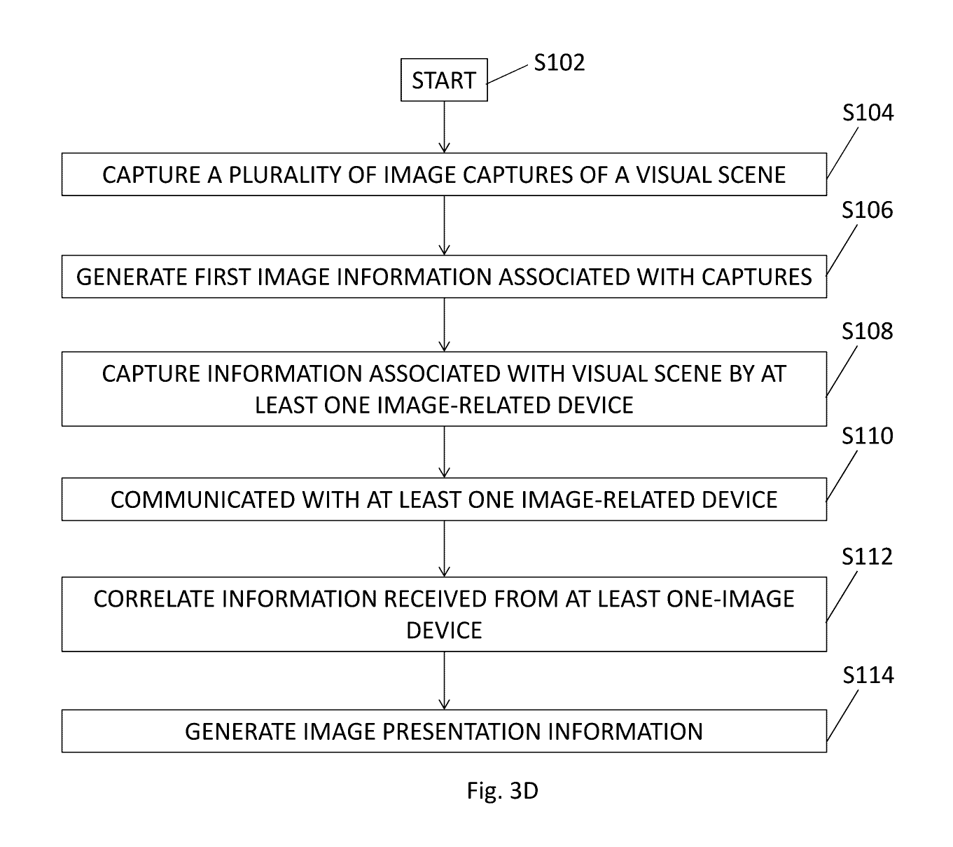

The present application can include processing, such as performed by hardware processors, to manage inferences that allow for attributes of each image. The attributes can be associated with: 1) the composite key frame; and 2) the full-frame capture(s) and/or spatial information associated therewith that relate to a visual scene. The inferences can be used to generate new image data that includes image information that exceeds the resolution of any one respective capture within the mosaic capture group and/or any one image or spatial data capture made by the second system during the one-second period of time. Image captures and/or associated data are employed to generate revised image data that represent an inferred image(s) of significantly higher resolution. In one or more implementations, image captures from the second system can be through the same lens as the “mosaic” captures and can employ the same capture device(s) 105 of the mosaic captures. Alternatively (or in addition), the “second system” captures can be taken through a lens that is offset from the camera, and/or can be at one or more locations thereby allowing for multiple image sources and/or other data (e.g., spatial data or other information representing aspects of the visual image area), such as via user computing device 104. FIGS. 3B-3C further illustrate such functionality.

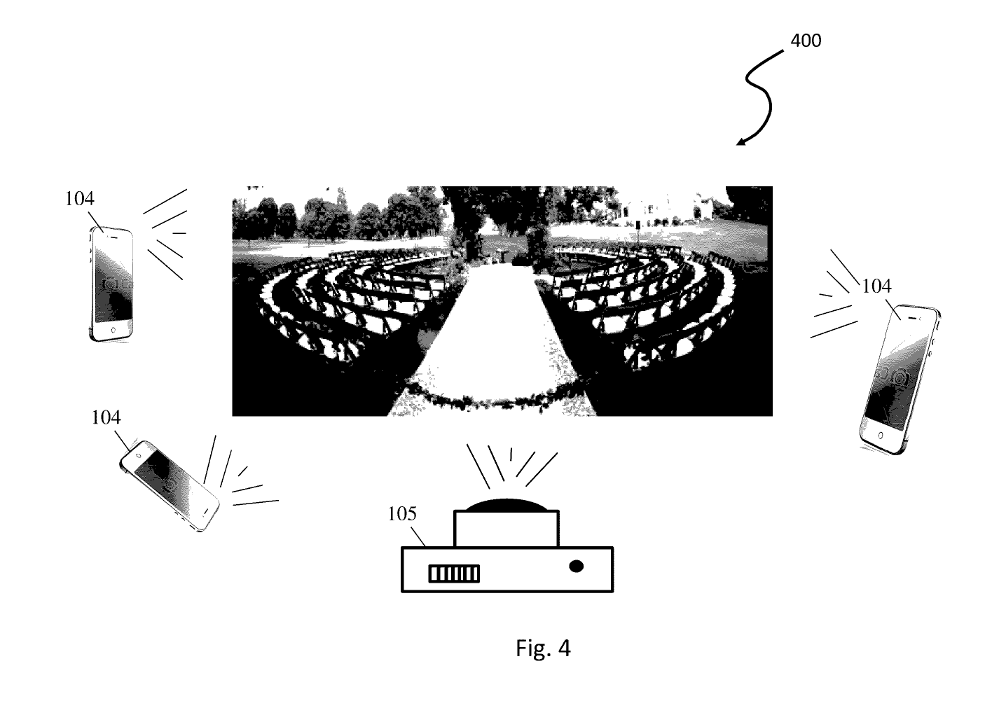

It should be appreciated that the present application provides for extremely efficient data generation and/or transmission. FIG. 4 illustrates use of an example single 4K capture device 105 (e.g., comprising an image sensor, emulsion-based, electronic or other suitable image capture element) that provides a plurality of captures 304′ and that are configurable to provide a mosaic key frame of a single desired visual image of up to 60 k (i.e., 15 captures 304′, each comprising 4K of data). As shown in FIG. 3A, the circle 300 illustrates the total lens-gathered light and represents the camera visible scene. Area 302 represents, for example, a frame of view of a 4K capture chip.

As shown and described herein, the total potential capture information from framed lens scene equals 60 k. For example and as shown in FIG. 3A, in a 15-position repositioning chip and/or image scenario, relative to the lens (or other light-gathering element) an image that allows for 15 screen captures per second, for example, informs 24 overall images for one second of overall media. The light facing side/shape of the 4K chip, in the example shown in FIG. 3 captures a sequence image captures 304 as follows: A1; A2; A3; B1; B2; B3; C1; C2; C3; D1; D2; D3; E1 E2; E3. Thereafter, the transmission sequence can be randomized, for example, as E3; A2; A1; D2; C1; C2; B1; B2; E1; B3; A3; D1; D2; D3; E2, thereby encrypting the sequence. A subsequent transmission, such as vis-à-vis a second system provides to a screening or other device information representing the sequence for de-encryption.

In accordance with the example shown in FIG. 3A, subsequent key frame captures, reverse the sequence of the original capture sequence to avoid unnecessary shifts back to the A1 position. However, an option can be provided to simply return expeditiously to continue the next mosaic capture pass-through for the various portions of the image gathered by the camera 105 representing the visual scene.

For example, a time period influenced by the 60 k mosaic “key frame” capture is 1 second, or 24 frames (total). A subsequent revision to the “key frame” image data, from lower resolution image data and/or separately gathered spatial data related to some image elements are featured at least within the “key frame.” Thus, the efficiency in the example configuration shown in FIG. 3A, potentially, is under 100 k of data to provide for 1440 k image data, allocated over 24 frames, utilizing a conventional, efficient and small 4K image capture chip/device. Moreover, the present application provides for a proprietary new media product, including for live media delivery systems and that makes piracy virtually impossible. A net effect of the present application includes an “expansion” or inference (rather than “compression/loss” of data) of image data which allows, for example, 1/9^{th} of the native data to be transmitted and that results in a powerfully encrypted mega-resolution result and usable at respective venue, such as for a theatrical release.

In one or more implementations of the present application, a computer-managed compositing of visual information associated with image captures 104′ eliminates redundant information that may be there-between. Such redundant information can represent, for example, small overlapping slivers of the visual scene Eliminating the redundancies allows for a seamless ultra-high resolution single key frame that can be used, for example, in relation to generating one or more subsequent images having a potential of up to 60 k in total image data, per generated image. By conveying a single sequence of fifteen (15) 4K captures per second of intended final media at 24 frames per second, for example, followed by a sequence of 2K full-frame images representing the entire desired visual scene as single full-frame captures, similar to a “video assist” or beam split image capture through the same lens as the mosaic captures, the total “data” load for providing 1440 k of image data representing 24 frames at 60 k, might be 108 k, or less: i.e., 48 k representing the 24 frames of 2K data, plus the one 60 k mosaic capture key frame. This increases data efficiency by over 13 times, while maintaining a virtually indistinguishable image result at 60 k as a function of the double-system image inferring system and method shown and described herein. Information generated and/or provided by the second system can provide all or partial image data, spatial information and/or other information that is pertinent to the desired visual scene and its various elements.

As described herein, in one or more implementations the present application provides for secure transmission or other conveyance of information shown and described herein, including, for example, as provided by the mosaic capture and second systems. The present application provides unique configurations for encryption in accordance with the mosaic captures and/or the second system captures, thereby obviating a need to alter, “break up” or otherwise affect the respective captures, themselves. In one or more implementations, a randomizing code can be generated and/or a sequencing code known to the system or otherwise provided can be imposed in relation to the full captures. In one or implementations, the code is provided via a separate data communication session, line, channel or the like, to increase the transmission security of the code.

The security of the present application is now further described with reference to an example implementation. One or more digital projector(s) are capable of manifesting a high resolution image for theatrical release. The projector(s) are configured to receive the full captures (or information generated in relation to them) in a jumbled order, and simultaneously, previously or subsequently receive information related to the sequence in which these jumbled images belong, in order to manifest the proper final images for theatrical screening (and/or other purpose such as post production or other proprietary screening purposes).

Thus, the mosaic composite image may be include recomposed captures 104′ in an order that is different from the ordering of the mosaic composite image's intended final version, relative to the one-second of footage. Once the intended sequence information is received, a “pirated” or other version of the composite image will not be correctly assembled and, accordingly, of little use. A computing device (including, potentially configured with a digital projector), also can be enabled to generate final inferred images from additional information that is generated and/or provided by the second system data. This additional information may be, for example, for proprietary screening or other uses, such as simple data transmission for postproduction, including sending raw footage from a location, or the like. Thus, even slow or limited data lines could be used to convey extremely high quality image data, through the inferring system herein, and thereby allowing for postproduction efforts to begin on a movie expeditiously, even from a remote and location scenario where data lines may not be equipped for large volume transfer rates.

In yet another configuration related to multidimensional image creation, information associated with the second system may be or otherwise include spatial information. In various configurations, the spatial information can be accompanied by visual information. For example, mobile (wireless) computing devices capture image information (e.g., from the device's camera) as well as forms of spatial information (e.g., global position system (“GPS”) and/or directional information). The spatial information can represent the direction in which the mobile computing device is pointed, height information, image cropping and/or other image capture dynamics). This enables dissemination of information about (as opposed to “of”) an object within a respective visible scene, and can include information that may not be visible from at least one associated vantage point, which contributes to the multi-dimensional nature of the present application.

For example, one capture device may be a primary capture device, or designated as such (e.g., “first” in a group) and can be configured to initiate a collective contribution of image and spatial data. In one or more implementations, a primary capture device collects at least visual information, which can involve the mosaic capture method and system disclosed herein. Second system device(s), which can include one or more mobile computing devices, can be configured to provide information, such as associated with attributes of objects within a respective scene area, which can be three-dimensional (“3-D”) and usable to generate final visual information that includes at least the visual information from the primary capture device.

In yet another configuration, multiple computing devices contribute to provide visual information and/or spatial information related to visual scene, including with regard to a 3-D scene. In such configuration, no single capture device may be configured as a “primary” capture device. However, data processing apparatus 102 or other computing device(s) can be configured to discern aspects of a scene, such as object(s,) within the 3-D visual scene area that can be common to multiple devices' visual and/or spatially informative captures. data processing apparatus 102 and/or other computing device(s) can be configured to identify commonality among information contributed by each respective device(s). This may occur by generating a selected number of final image(s), which may provide for creating (or re-creating) the 3-D image within a selected display device.

As noted herein, the present application includes features that provide, contribute to and increase security. In one configuration, as multiple devices contribute visual and/or spatially informative information, useful in generating a collaborative 3-D environment, yet another means for capture associated encryption is provided as an aspect of the present application. As each device 104 contributes information useful in allocating information within a multidimensional rendition of the collectively captured/sampled environment, related to the desired visual scene, the opportunity to purposefully randomize or scramble the order in which these distinct devices' information is at least conveyed, for example, provides the opportunity for second system de-scrambling of this simple disordering to re-establish a proper allocation information. Thus, if a simple 3-D environment were generated as two offset images related to the same visual scene, the de-scrambling code would be essential in establishing, potentially many times within a single scene, which of the two (or more) offset images the visual information associated with a contributing device is to be designated to, for manifesting/display.

For example, three mobile computing devices transmit information wirelessly to a computing device. The information includes visual and positional data. The positional data includes GPS information and device logistics, such as a respective angle and height of the device. In addition, information is provided that relates to recreating the 3-D scene. This involves transmitting a representation of the data from each device in a sequence that is different from the relative position that the respective device actually occupied in the environment. For example, and with reference to FIG. 3A, the captures 304′ are scrambled to be ordered as 132312132312. In “correcting” or unscrambling the captures 304′ into the proper sequence, 123123123, data processing apparatus 102 receives the transmission and allocates image information to its proper order, spatially, thereby re-establishing the 3-D scene. Any unintended recipient (e.g., a computing device that illegally or otherwise intercepts the captures 304′) that is not authorized or meant to view the multi-dimensional images can only recreate a jumbled representation of the 3-D scene. Such recipient is unable to view the scene without having access to information representing the proper sequence of the contributing visual and/or spatial information by a linked device. In one or more implementations, the transmission of the three mobile computing devices occurs in a proprietary way (e.g., as a function an encryption method or over one or more particular transmission channels or paths). This further improves one or more computing devices by providing enhanced security measures to protect copyright and other legal concerns.

In one or more implementations, data processing apparatus can be configured to provide subscribership for users of respective computing devices to view and experience a 3-D movie, concert, wedding or other multimedia event. By employing the mosaic key frame configuration shown and described herein that includes at least one primary imaging device, one or more contributing devices provide additional information to suggest how the extreme resolution captures might be recreated (inferred) at various angles, including based on computer managed and distinguishable attributes of the desired 3-D visual scene and/or its elements, such as distinct objects/components.

Thus, one or more high resolution captures can be “informed” by lower resolution or other type of information, such as spatial data, to allow for a 3-D recreation in motion media but a 3-D environment of computer inferred high resolution image(s), had the image(s) actually been captured from the various contributing devices at a higher resolution. Indeed, limits on resolution inference may be affected by the quality and dynamics of the contributing captures 304 themselves, which may mean portions of the generated 3-D recreation of an environment may have “richer” areas than others, in relation to at least image quality and multidimensional dynamics.

Moreover, such issues can even inform a system, such as a wireless application based system, to suggest “where” in the scene another device and/or existing device might be placed, to enhance the overall quality and result of the 3-D visual recreation.

FIG. 4 illustrates a mosaic capture device 105 and a second unit comprising a plurality of capture devices 104 (configured as smartphones) that work to capture a wedding event, i.e., the visual scene 400. The mosaic capture device 105 provides an option of a primary high resolution capture aspect, with multiple wireless devices 104 (such as iPhones) providing spatial and visual information (in this example) further informing the generation of the 3-D environment subsequently viewable, potentially on a proprietary basis. Information can be correlated, for example, by data processing apparatus 102, including from one or more image and spatial data sources, thereby generating a final 3-D motion image version.

In one or more configurations, capture device 105 can be enabled to capture a mosaic key frame, of a plurality of image portion captures, such represented in FIG. 3A, with at least some of the information from the key frame being used to generate one or more final multidimensional images informed further by at least one additional device, such as wireless device 104. In yet another configuration, at least one spatial sampling component can be provided as an aspect of device 105, which is used to affect the generation of multidimensional image(s) with or without additional spatial information relevant to aspects of the desired visual scene provided by associated wireless (or otherwise compatibly linked) components, 104. High resolution captures can be provided from one or more primary vantage points, and lesser captures (e.g., visual and other information) can contribute to a collaborative 3-D final rendition.

Turning now to the flow diagram shown in FIG. 3D, the process starts at step S102. Thereafter, a first subsystem that includes at least one image capture device captures a plurality of image captures of a visual scene (S104). Thereafter first image information that is associated with at least one of the plurality of image captures is generated by the first subsystem (step S106). A second subsystem that includes at least one image-related device captures information associated with the visual scene, wherein at least one image-related device of the second subsystem is positioned offset of at least one image capture device of the first subsystem (step S108). At least one processor communicates (e.g., wirelessly or wired) with at least one image-related device of the second subsystem (step S110). Information received from at least one image-related device of the second subsystem is correlated by at least one processor with at least some of the first image information (step S112). Thereafter, image presentation information is generated as a function of the correlated information, wherein the generated image presentation information is usable to present an altered version of at least one of the plurality of image captures (step S114). Thereafter, the process ends (not shown).

As shown and described with reference to FIG. 4, visual information (e.g., from capture device 105) and positional data (e.g., from wireless devices 104) can be transmitted to one or more data processing apparatuses 102 to inform a final encrypted 3-D motion version of the wedding, including allocation of visual information from the high definition camera 105. In one or more alternative implementations, the camera 105 can be configured as simply another wireless device as well.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. It is to be understood that like numerals in the drawings represent like elements through the several figures, and that not all components and/or steps described and illustrated with reference to the figures are required for all embodiments or arrangements.

The flow diagram and block diagrams in the figures illustrate an example architecture, functionality, and operation of possible implementations of systems, methods and computer program products according to various embodiments and arrangements. In this regard, each block in the flow diagram or block diagrams can represent a module, segment, or portion of code, which comprises one or more executable instructions for implementing the specified logical function(s). Furthermore, in some alternative implementations the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagram, and combinations of blocks in the block diagrams and/or flow diagram, can be implemented by special purpose hardware-based systems that perform the specified functions or acts, or combinations of special purpose hardware and computer instructions.

Although many of the examples shown and described herein regard distribution of coordinated presentations to a plurality of users, the invention is not so limited. Although illustrated embodiments of the present invention have been shown and described, it should be understood that various changes, substitutions, and alterations can be made by one of ordinary skill in the art without departing from the scope of the present invention.

What is claimed is:

1. A system, comprising:
a first subsystem that includes at least one image capture device configured to capture a plurality of image captures of a visual scene and to generate first image information associated with at least one of the plurality of image captures;
a second subsystem that includes at least one image-related device positioned offset of at least one image capture device of the first subsystem; and configured to capture information associated with the visual scene; and
at least one processor configured to:
communicate with at least one image-related device of the second subsystem;
correlate information received from at least one image-related device of the second subsystem with at least some of the first image information; and
generate image presentation information as a function of the correlated information;
wherein the generated image presentation information is usable to present an altered version of at least one of the plurality of image captures.

2. The system of claim 1, wherein the information collected by the second subsystem is at least one of visual information and spatial information.

3. The system of claim 2, wherein the second subsystem collects information associated with one or more objects within the visual scene.

4. The system of claim 1, wherein the captured information from at least one image-related device of the second subsystem regards at least one image having a resolution that is lower than that of each of the plurality of image captures.

5. The system of claim 1, wherein the at least one processor is configured to alter at least one of: at least some of the first image information and at least one of the plurality of image captures.

6. The system of claim 1, wherein at least one image-related device of the second subsystem is synchronized with at least one image capture device of the first subsystem.

7. The system of claim 1, wherein the at least one processor is configured to identify commonality among the information captured by at least one image-related device of the second subsystem and the first image information.

8. The system of claim 1, wherein the image presentation information is usable by a respective device to create or re-create at last one multi-dimensional image.

9. The system of claim 1, wherein the image presentation information is usable to generate at least one image having a resolution that is higher than that of each of the plurality of image captures.

10. The system of claim 1, wherein the at least one processor is configured to propose a respective position of at least one image-related device of the second subsystem in relation to at least one image capture device of the first subsystem.

11. The system of claim 11, wherein at least some of the image presentation information is encrypted and at least some of the image presentation information includes information for unencrypting the encrypted at least some image presentation information.

12. A method, comprising:
capturing, by a first subsystem that includes at least one image capture device, a plurality of image captures of a visual scene;
generating, by the first subsystem, first image information associated with at least one of the plurality of image captures;
capturing, by a second subsystem that includes at least one image-related device, information associated with the visual scene, wherein at least one image-related device of the second subsystem is positioned offset of at least one image capture device of the first subsystem;
communicating, by at least one processor, with at least one image-related device of the second subsystem;
correlating, by at least one processor, information received from at least one image-related device of the second subsystem with at least some of the first image information; and
generating, by at least one processor, image presentation information as a function of the correlated information;
wherein the generated image presentation information is usable to present an altered version of at least one of the plurality of image captures.

13. The method of claim 12, wherein the information collected by the second subsystem is at least one of visual information and spatial information.

14. The method of claim 13, further comprising collecting, by the second subsystem, information associated with one or more objects within the visual scene.

15. The method of claim 12, further comprising altering, by the at least one processor, at least one of: at least some of the first image information and at least one of the plurality of image captures.

16. The method of claim 12, wherein the captured information from at least one image-related device of the second subsystem regards at least one image having a resolution that is lower than that of each of the plurality of image captures.

17. The method of claim 12, further comprising identifying, by the at least one processor, commonality among the information captured by at least one image-related device of the second subsystem and the first image information.

18. The method of claim 12, wherein the image presentation information is usable by a respective device to create or re-create at last one multi-dimensional image.

19. The method of claim 12, wherein the image presentation information is usable to generate at least one image having a resolution that is higher than that of each of the plurality of image captures.

20. The method of claim 12, further comprising proposing, by the at least one processor, a respective position of at least one image-related device of the second subsystem in relation to at least one image capture device of the first subsystem.

21. The method of claim 12, wherein at least some of the image presentation information is encrypted and at least some of the image presentation information includes information for unencrypting the encrypted at least some image presentation information.
